(19) United States
(12) Patent Application Publication
(10) Pub. No.: US 2012/0105478 A1
(43) Pub. Date: May 3, 2012

(54) Presenting Content on Electronic Paper Displays

(75) Inventor: Kenneth Soohoo, Redwood Shores, CA (US)

(73) Assignee: Monotype Imaging Inc.

(21) Appl. No.: 12/914,428

(22) Filed: Oct. 28, 2010

(51) Int. Cl. G09G 3/34; G09G 5/00

(52) U.S. Cl. 345/635; 345/107

(57) ABSTRACT

A computing device includes a processor configured to execute instructions to define a group of substantially non-overlapping segments of an electronic paper display. The computing device also includes a display controller configured to individually refresh the substantially non-overlapping segments of the electronic paper display in a sequential manner, and control content presentation in each refreshed segment.

### BACKGROUND

This description relates to presenting content on electronic paper displays.

In the ever-expanding field of computers and display technology, devices have been developed to mimic the appearance of ordinary paper and potentially provide a viable substitute for conventional paper as a print medium. Along with being environmentally friendly, such technology may be used in devices that are approximately the same size as a stack of paper (e.g., the size of a book) or even an individual sheet. To simulate a printed page, such devices may also exploit energy conserving techniques and statically present content such as text and images.

### SUMMARY

The systems and techniques described here relate to individually refreshing and presenting content on segments of an electronic paper display.

In one aspect, a computing device-implemented method includes individually refreshing substantially non-overlapping segments of an electronic paper display in a sequential manner. The method also includes, upon being refreshed, presenting content in each individual refreshed segment.

Implementations may include any or all of the following features. The sequential manner may include refreshing adjacent segments in series. The sequential manner may include refreshing horizontally or vertically adjacent segments in series. The sequential manner may visually simulate turning a page on the electronic paper display. Refreshing an individual segment may include applying a charge to a corresponding portion of the electronic paper display. The segments may include at least sixteen segments (e.g., thousands of segments). The sequential manner may include delaying the refreshing of one segment until another segment is refreshed, presents content, or other similar events or combination of events.

In another aspect, a computing device includes a processor configured to execute instructions to define a group of substantially non-overlapping segments of an electronic paper display. The computing device also includes a display controller configured to individually refresh the substantially non-overlapping segments of the electronic paper display in a sequential manner, and control content presentation in each refreshed segment.

Implementations may include any or all of the following features. The processor may be configured to divide the electronic paper display into portions to define the group of substantially non-overlapping segments. The electronic paper display may reflect ambient light to present content. The electronic paper display may be included in the computing device. The electronic paper display may be an electrophoretic display. The substantially non-overlapping segments may have a variety shapes such as being rectangular shaped. The substantially non-overlapping segments may be horizontally adjacent, vertically adjacent or other type of orientation or combination thereof. The display controller may apply a charge to a corresponding portion of the electronic paper display to refresh a segment. The sequential manner may visually simulate turning a page on the electronic paper display. The sequential manner includes delaying the refreshing of one segment included in the group of segments until another segment is refreshed, presents content, or other similar events or combination of events.

In another aspect, one or more computer readable media stores instructions that are executable by a processing device, and upon such execution cause the processing device to perform operations that include individually refreshing substantially non-overlapping segments of an electronic paper display in a sequential manner. The operations also include, upon being refreshed, presenting content in each individual refreshed segment.

Implementations may include any or all of the following features. The sequential manner may include refreshing adjacent segments in series. The sequential manner may include refreshing horizontally or vertically adjacent segments in series. The sequential manner may visually simulate turning a page on the electronic paper display. Refreshing an individual segment may include applying a charge to a corresponding portion of the electronic paper display. The segments may include at least sixteen segments (e.g., thousands of segments). The sequential manner may include delaying the refreshing of one segment until another segment is refreshed, presents content, or other similar event or combination of events.

These and other aspects and features and various combinations of them may be expressed as methods, apparatus, systems, means for performing functions, program products, and in other ways.

Other features and advantages will be apparent from the description and the claims.

### DESCRIPTION OF DRAWINGS

FIG. 1 is an exemplary electronic paper display device.

FIG. 2 illustrates an electronic paper display device transitioning between pages of digital text.

FIG. 3 illustrates dividing an electronic paper display into segments.

FIG. 4 illustrates refreshing and presenting content on segments of an electronic paper display.

FIG. 5 is a block diagram of components of an electronic paper display device.

FIG. 6 is an example flow chart of operations of an electronic paper display device.

FIG. 7 is a block diagram of exemplary electronic devices.

### DETAILED DESCRIPTION

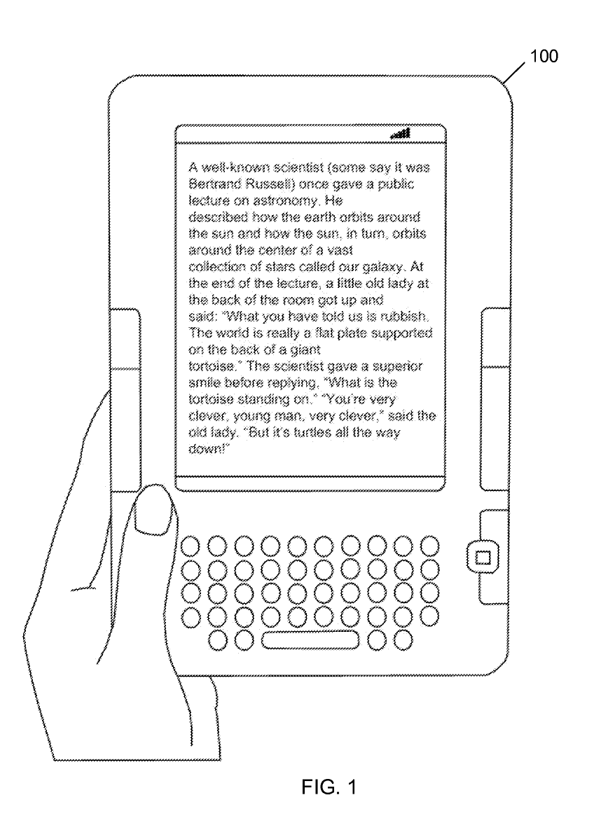

Referring to FIG. 1, an exemplary electronic paper display device 100 is illustrated that may present various types of digital media such as text and images. Such devices, which may also be referred to as electronic ink or e-paper display devices utilize technology to mimic the appearance of ordinary ink on paper. To provide such media presentations, the display may reflect light (e.g., ambient light) similar to conventional paper rather than using backlighting techniques (e.g., implemented in panel displays and computer monitors) to emit light, which are typically used for presenting more dynamic types of content (e.g., user interfaces, video, etc.).

One or more types of technologies may be used for producing such light reflective displays. For example, electrophoretic technology may be implemented such that charged particles (e.g., one micrometer diameter titanium dioxide particles) are arranged (based upon an applied electric field) to present digital media such as text and static images. In general, by applying a voltage across two plates that provide a display surface, particles located between the plates appropriately migrate in an electrophoretic manner (e.g., to the plate charged opposite to the charge of the particles). As such, when the particles are located near the plate closer to the viewer, the display surface may appear white in color since the particles tend to scatter incident light (e.g., ambient light) back to the viewer. When applied with a charge such that the particles are positioned near the plate further from the viewer, the display appears dark in color since the incident light is absorbed by a fluid within which the particles are suspended (e.g., a combination of dye and oil such as hydrocarbon oil). By dividing the display into elements (e.g., a matrix of pixels), appropriate voltages may be applied to each element to create recognizable patterns of reflecting and absorbing regions (e.g., text characters). Voltage levels may also be adjusted to produce partially charged particles to provide levels of gray-colored regions.

Since the presented digital media (e.g., text, images) is generally static, such devices typically do not constantly update their displays. As such, an image may be held by the device without continuously applying electricity and adjusting pixels, thereby reducing power consumption and potentially viewer eye strain (e.g., making the content easier to read). However, due to the relatively low update rate (compared to devices that use light emitting techniques) images may remain after changing a display (e.g., presenting the next page of text). To reduce the occurrence of such images (often referred to as ghost images), electronic paper display devices typically refresh their displays (e.g., cycle every pixel to the color white, then the color black, and then back to white) to neutralize the ghosting effect.

In this particular illustration, the electronic paper display is provided in a lightweight, low power, portable device that is approximately the size of a book (e.g., similar to the Kindle™ marketed by Amazon of Seattle, Wash., USA, the Nook™ marketed by Barnes & Noble, Inc. of New York City, N.Y., USA, etc.). However, such display technology may also be incorporated into other platforms of various sizes. For example, cellular telephones and similar electronic devices may be designed to include such displays. Larger scale platforms such as billboards and other types of signage may also incorporate such electronic paper display technology.

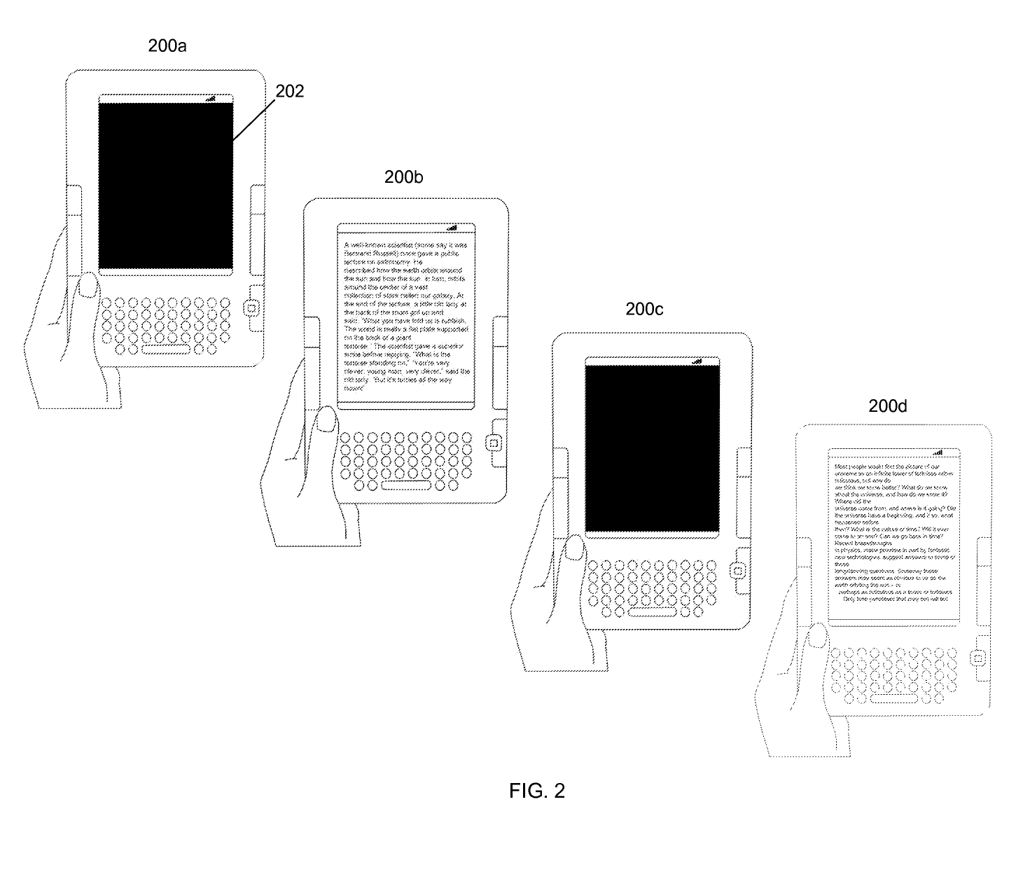

Referring to FIG. 2, a series of representations 200a, b, c, d of an electronic paper display device illustrate refreshing the display prior to presenting digital media (e.g., text). In this example, prior to displaying electronic text, each pixel included in the display is charged and correspondingly presents a dark color (e.g., the color black) to the viewer. As shown in the representation 200a, an entire display 202 is presented in the color black prior to presenting the first page of text in representation 200b. Little energy is consumed by the display device as the page is presented to the viewer for reading. When ready to move forward, the viewer typically initiates the transition from the currently presented text to the next corresponding portion of text (e.g., page 2 of a book). However, similar to representation 200a, the entire display of the device is refreshed (one or more times) to perform the necessary function of reducing the appearance of ghost images. As such, the display collectively flashes as each pixel is placed in a fully charged state, as illustrated in representation 200c, prior to presenting the next page of text (as provided by representation 200d). Such display transition flashes may be noticeable for a relatively short period of time. For example, approximate transition times of 750 millisecond may be needed by some devices (for some products page transition time period of 0.5 sec to 2 may be needed). For such time periods, the flashes may be distracting to some viewers and possibly annoying enough to cause a negative viewing experience. Further, such visual flashes may be detrimental to the health of a viewer. For example, such repetitive flashes may contribute to an epileptic seizure or other type of abnormality in a relatively small percentage of viewers. As such, reducing or even removing such visual flashes during content transitions may improve a viewer's experience and potentially reduce the probability of harmful events to the viewer.

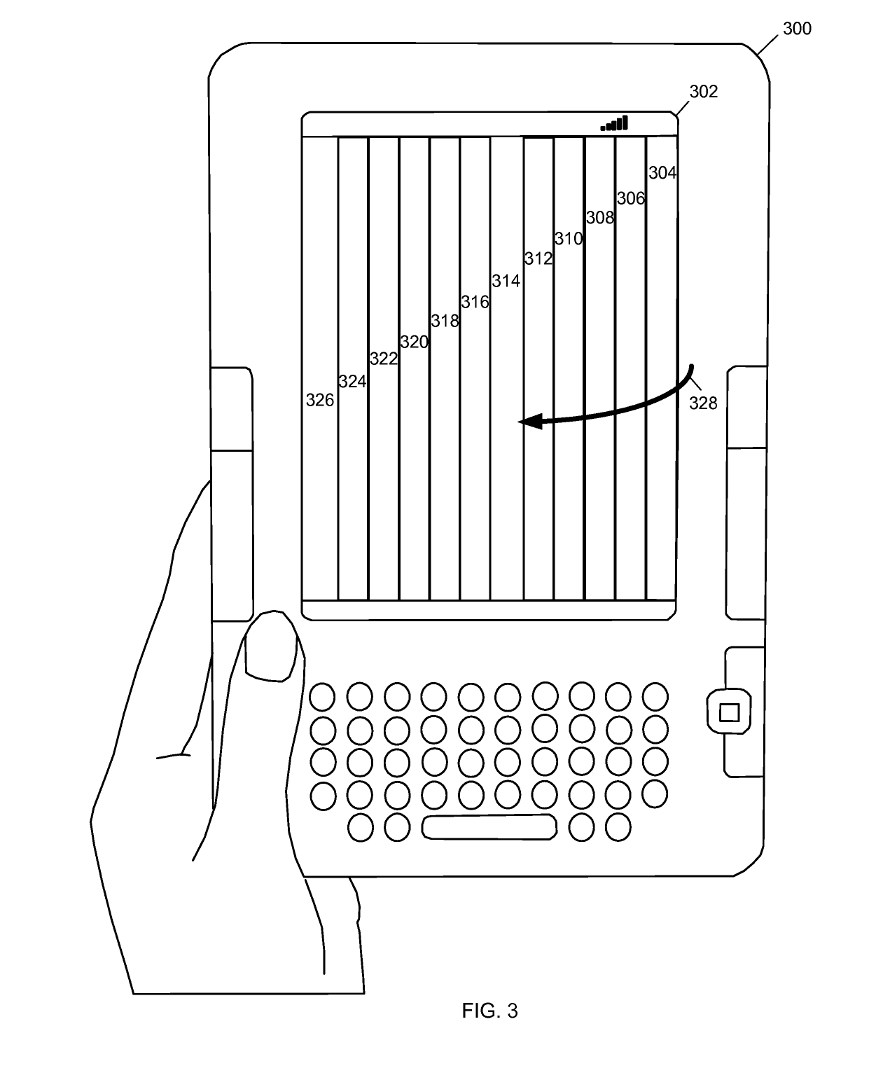

Referring to FIG. 3, an electronic paper display device 300 divides its display into segments to reduce the effects of refreshing the entire display. By separately refreshing the individual segments over a period of time, the visual flash presented to a viewer is distributed over time and is reduced, thereby becoming less noticeable (and potentially less harmful). As shown in the figure, a display 302 of the device 300 is divided into twelve rectangular-shaped segments 304-326 that are substantially non-overlapping and are adjacently positioned in a horizontal pattern. Various other types of segmenting and patterns may also be implemented individually or in combination. For example, segments may be defined to extend from the bottom to the top of the display 302 (and appear to be vertically stacked). Segments may also extend along one or more diagonals (e.g., a diagonally oriented axis) of the display 302. Along with being similarly oriented, as in the illustrated example, each of the segments 304-326 are approximately equivalent in size and shape. However, segments of different sizes and shapes may also be implemented to reduce the visual flash effect presented to a viewer. The display may also be divided into more or less segments, for example, the display may be divided into thousands of segments or a few segments (e.g., eight or four segments).

Along with the segment size, shape and patterning of the segments, the distracting visual flash effect may be controlled by the manner in which each segment is refreshed and updated (e.g., with new text). For example, segments may be refreshed and updated from right to left, top to bottom, lower left to upper right (for segments positioned on a diagonal), in opposite directions, or in different manners. Based upon controlling the time delay between refreshing adjacent segments, other visual effects may be presented to a viewer. For example, by refreshing a segment as an adjacent completes a refreshing cycle, the display 302 may appear to change with a rolling effect (e.g., from right to left) and may give an appear similar to a book page being turned. As represented with arrow 328, by completing the refreshing cycle of the segment 304 prior to initiating the refreshing of segment 306 (and continuing in a similar manner from right to left to the segment 326) a viewer may perceive the relatively small sequence of visual flashes (associated with each segment refresh cycle) as representing the turning of a book page. Similar to a right to left rolling effect, other sequences may also be implemented. For example, refreshing sequences may provide vertical or diagonal rolling effects, or simulate other patterns. To simulate a book page being turned, the content presented by each segment may be updated directly after the corresponding refresh cycle is complete. However, content updating may be delayed in time (relative to completing a refresh cycle). For example, once two or more segments have completed their respective refresh cycles, content may be presented in the multiple segments (rather than individually updating the content in each segment).

Various time periods may be used for refreshing and updating display segments. For example, various time periods may be used to sequentially refresh and update adjacent segments (e.g., moving from right to left across the display). Such time periods may extend across a variety of ranges, e.g., a range of 8 millisecond to 100 millisecond. For example, using a time period of 16 millisecond for 12 segments, a delay of 192 millisecond may be added to the update time, e.g., of 750 millisecond. As such, a time period of approximately 942 millisecond (or just under 1 second) is needed to transition from one page to another and divide a relatively large visual flash into less noticeable flash segments. Various other time ranges may also be implemented based upon the platform presenting the content (e.g., the display of a cellular phone, a billboard, etc.).

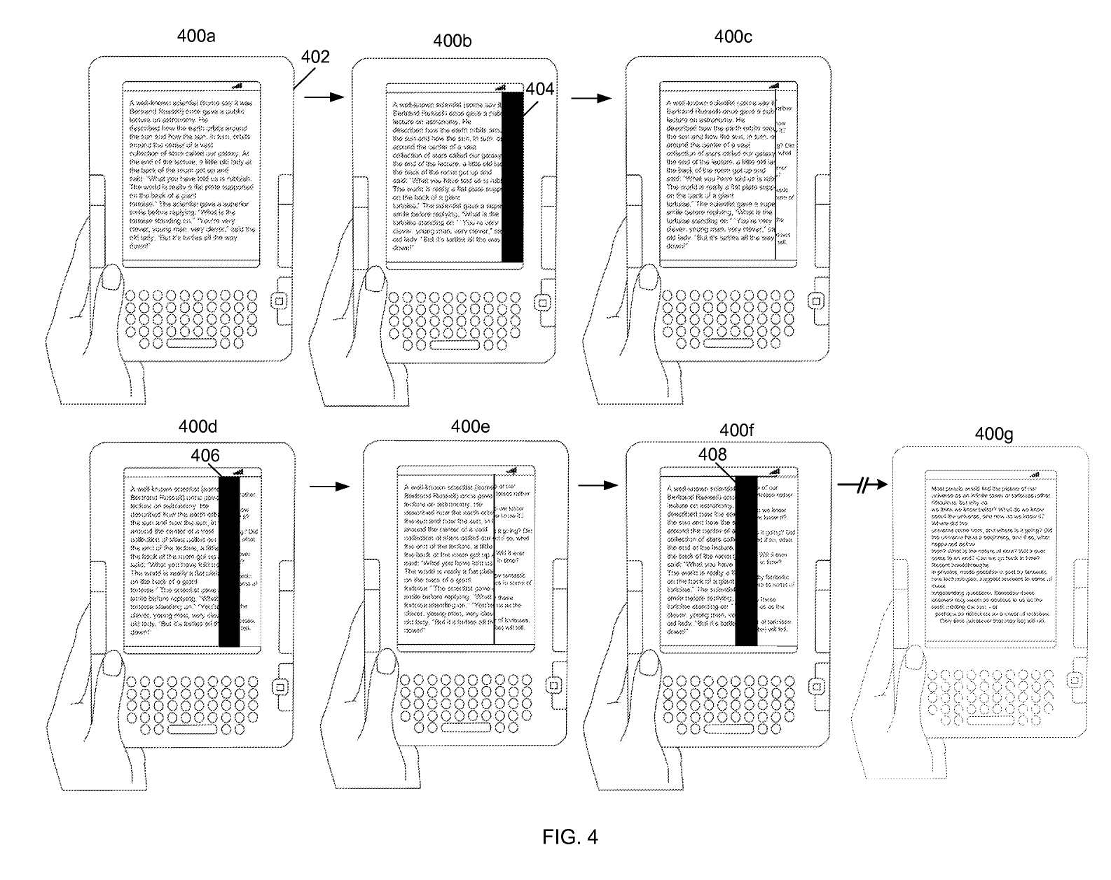

Referring to FIG. 4, a series of representations of a electronic paper display device illustrates one example of sequentially refreshing and updating a display divided into segments. In this particular example, the illustration represents the transition from one page of digital text (e.g., page 1 of a book) to the next corresponding page (e.g., page 2 of the book). Such a transition may occur within a relatively short period of time (e.g., a second or a faction of second). As such, a series of relatively small flashes appear to move across the display and may not be overly distractive to the viewer. In representation 400a, an electronic paper display device 402 is illustrated as presenting a first page of text (e.g., from an electronic version of a book). Upon a request to present the next page (e.g., from viewer interaction with the display device), the display is divided into segments, and, refreshing and updating of each segment is initiated. In this particular example, refreshing and updating occurs from the right side to the left side of the display (from the viewer's perspective). Representation 400b illustrates the right-most segment 404 of the display being refreshed. In this particular arrangement, a voltage is applied to the portion for the display that defines the segment being refreshed thereby causing the segment to appear dark in color for a brief period of time. Following the small visual flash, as illustrated with representation 400b, the right-most segment of the display is updated with the appropriate digital text from the next page (as illustrated with representation 400c). Once updating of the segment is complete, operations are executed for refreshing and updating an adjacent segment (moving from right to left across the display). As illustrated in representation 400d, the adjacent segment 406 is refreshed and similarly projects a dark color. Updating the content presented by the segment is next provided, as illustrated by representation 400e. As shown, the portion of the display presenting part of the second page of text has grown to include two segments. Again, once refreshing and updating is complete, similar operations are executed on the next adjacent segment. As illustrated in representation 400f, the next adjacent segment 408 is refreshed and correspondingly presents the segment in a dark color. Updating the presented content follows with the segment 408 presenting the appropriate portion of the next page of text (not shown). In a similar manner, the remaining segments of the display are refreshed and updated by moving from right to left across the display. Upon refreshing the updating the left-most segment, as illustrated in representation 400g, the entire second page of text is presented by the display device 402. While this particular example illustrated segments being refreshed and updated from right to left across the display, other refreshing and updating patterns may be used. For example, refreshing and updating could occur from left to right, top to bottom, bottom to top or moving in any direction across the display. Other patterns may be used for refreshing and updating segments, for example, two or more segments may be refreshed and updated in parallel (e.g., the left-most segment and the right-most segment) and moving across the display in multiple directions (e.g., moving left to adjacent segments from the right-most segment, moving right to adjacent segments from the left-most segment, etc.).

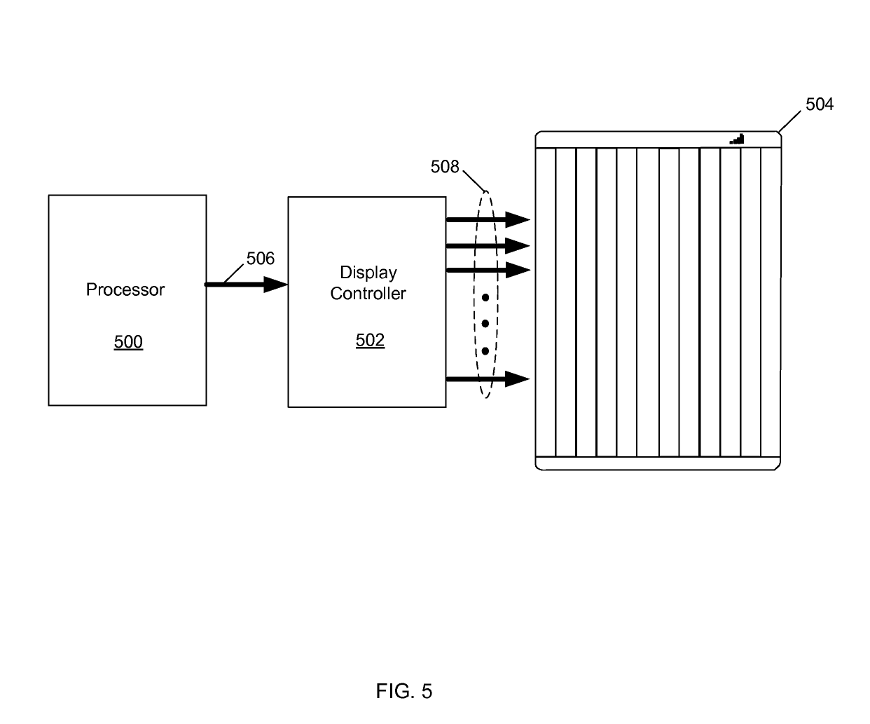

Referring to FIG. 5, various types of implementations and architectures may be used for executing operations associated with dividing the display of an electronic paper display device into segments and, refreshing and updating the segments to reduce disruptive “flashes”. For example, software, hardware or combinations of software and hardware architectures may be incorporated into an electronic paper display device. In one particular implementation, a processor-based architecture may provide operations for dividing a display into segments along with refreshing and updating the segments. In general, a processor 500 (e.g., a microprocessor) executes instructions and provides commands and data to a display controller 502 that correspondingly controls e.g., the segmenting, refreshing and updating of a display 504 of an electronic paper display device (e.g., such as the display device 300 shown in FIG. 3). In one arrangement, the display controller 502 manages the application of electric charges to the display 504 for adjusting the appearance of the display 504 as directed by the processor 500.

The processor 500 may also execute operations for preparing content (e.g., digital text) for presentation on the display 504 and providing the content (as represented by arrow 506) to the content display controller 502 for additional processing prior to presentation. For example, upon being provided content (e.g., a page of digital text), the processor 500 may define the segments of the display 504 and produce a corresponding portion of the content to be displayed as the first segment (e.g., the right-most display segment) along with the other segments. Various parameters may factor into determining the number of segments that the display 504 may be divided. For example, the management capabilities of the display controller 502 may provide a limiting factor. To illustrate, the display controller 502 (e.g., an Electronic Paper Display, EPD, Controller, marketed by Epson of Suwa, Nagano, Japan) may be capable managing a range of display segments (e.g., twelve, sixteen, etc.), as represented by the group of arrows 508. As such, dividing the display 504 may be limited to the maximum number of segments that may be managed by the display controller 502 (e.g., divide the display into twelve, sixteen, etc. segments).

Once the segment content is received from the processor 500, the display controller 502 may refresh the portion of the display 504 associated with the corresponding segment (e.g., the right-most segment). After being refreshed, the appropriate portion of the display 504 may be updated with the content provided by the processor 500. In some arrangements, operations may be executed in parallel. For example, as the display controller 502 refreshes a portion of the display 504 (e.g., the right-most segment of the display), which may call for several hundred milliseconds, the processor 500 may be preparing content portions for one or more additional segments (e.g., adjacent to the right-most segment) to be presented on the display 504.

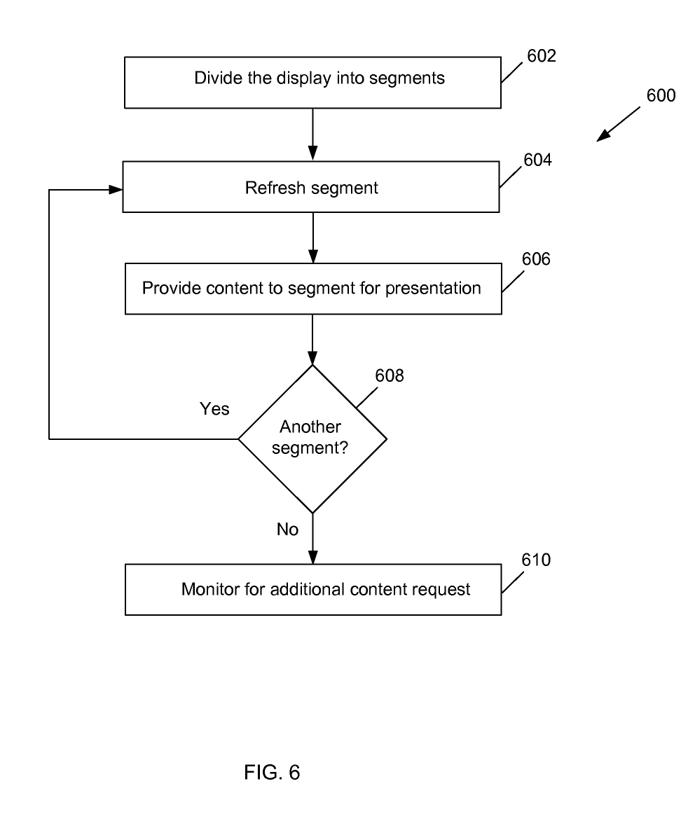

Referring to FIG. 6, a flowchart 600 represents operations of a computing device such as an electronic paper display device to present content (e.g., digital text) in a manner to reduce distracting visuals such as transient flashes of an electrophoretic display (during a refresh cycle). Such operations are typically executed by components (e.g., processors, display controllers, etc.) included in a electronic paper display device (e.g., display device 300 shown in FIG. 3), however, operations may be executed multiple computing devices. Along with being executed at a single site (e.g., at the location of a electronic paper display device), operation execution may be distributed among two or more locations.

Operations of the electronic paper display device may include dividing 602 the display of the device into segments (e.g., sixteen rectangular shaped that extend horizontally across the display). Upon defining the segments, operations may also include refreshing 604 one or more of the segments. For example, a segment located at the right-most portion of the display be refreshed by applying an appropriate voltage level. Once refreshed, operations may also include providing 606 content for presenting in the refreshed segment of the display. For example, content may include digital text associated with the segment for presenting the next page of an electronic version of a book, reference text or other type of periodical. Once presented, operations may include determining 608 if another segment of the display needs to be refreshed and provided content for presentation. If another segment is present, operations may include appropriately repeating the refresh operation and providing content for presentation. Once each segment of the display has been refreshed and provided appropriate content, operations may include monitoring 610 for a request for additional content. For example, after presenting a page of digital text, the viewer may read though the text and request (e.g., through interaction with the display device) that the next page of text be presented.

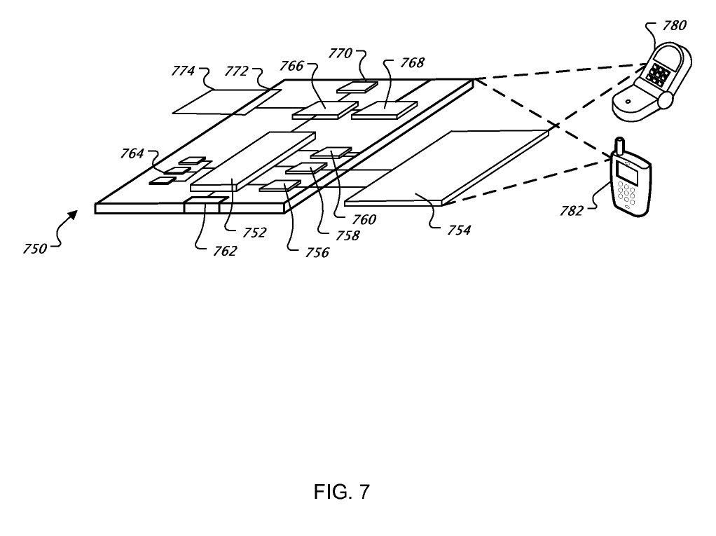

FIG. 7 is a block diagram of computing devices that may be used and implemented to perform operations associated dividing a display into segments, refreshing the segments and providing content to the segments for presentation. As such, the computing systems may provide operations similar to an electronic paper display device (e.g., such as the display device 300 shown in FIG. 3). Along with representing various forms of digital computers (e.g., laptops, etc.), computing device 750 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 750 includes a processor 752, memory 764, an input/output device such as a display 754, a communication interface 766, and a transceiver 768, among other components. The device 750 may also be provided with a storage device, such as a micro-drive or other device, to provide additional storage. Each of the components 750, 752, 764, 754, 766, and 768, are interconnected using various buses, and several of the components may be mounted on a common motherboard or in other manners as appropriate.

The processor 752 can process instructions for execution within the computing device 750, including instructions stored in the memory 764. The processor may also include separate analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. Along with light reflective displays (e.g., that incorporate electrophoretic technology), the display 754 may use other appropriate display technology. The display interface 756 may comprise appropriate circuitry for driving the display 754 to present graphical and other information to a user. The control interface 758 may receive commands from a user and convert them for submission to the processor 752. In addition, an external interface 762 may provide communication with processor 752, so as to enable near area communication of device 750 with other devices. External interface 762 may provide, for example, for wired communication (e.g., via a docking procedure) or for wireless communication (e.g., via Bluetooth or other such technologies).

The memory 764 stores information within the computing device 750. In one implementation, the memory 764 is a computer-readable medium. In one implementation, the memory 764 is a volatile memory unit or units. In another implementation, the memory 764 is a non-volatile memory unit or units. Expansion memory 774 may also be provided and connected to device 750 through expansion interface 772, which may include, for example, a SIMM card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provided as a security module for device 750, and may be programmed with instructions that permit secure use of device 750. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, memory on processor 752, or a propagated signal.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS receiver module 770 may provide additional wireless data to device 750, which may be used as appropriate by applications running on device 750.

Device 750 may also communicate audibly using audio codec 760, which may receive spoken information from a user and convert it to usable digital information. Audio codex 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smart phone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the systems and methods have been described, it should be recognized that numerous other applications are contemplated. Accordingly, other embodiments are within the scope of the following claims.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

While this specification contains many specifics, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A computing device-implemented method comprising:
individually refreshing substantially non-overlapping segments of an electronic paper display in a sequential manner; and
upon being refreshed, presenting content in each individual refreshed segment.

2. The computing device-implemented method of claim 1 in which the sequential manner includes refreshing adjacent segments in series.

3. The computing device-implemented method of claim 1 in which the sequential manner includes refreshing horizontally adjacent segments in series.

4. The computing device-implemented method of claim 1 in which the sequential manner include refreshing vertically adjacent segments.

5. The computing device-implemented method of claim 1 in which the sequential manner visually simulates turning a page on the electronic paper display.

6. The computing device-implemented method of claim 1 in which refreshing an individual segment includes applying a charge to a corresponding portion of the electronic paper display.

7. The computing device-implemented method of claim 1 in which the segments include at least sixteen segments.

8. The computing device-implemented method of claim 1 in which the sequential manner includes delaying the refreshing of one segment until another segment is refreshed.

9. The computing device-implemented method of claim 1 in which the sequential manner includes delaying the refreshing of one segment until another segment is refreshed and presents content.

10. A computing device comprising:
a processor configured to execute instructions to define a group of substantially non-overlapping segments of an electronic paper display; and
a display controller configured to individually refresh the substantially non-overlapping segments of the electronic paper display in a sequential manner, and control content presentation in each refreshed segment.

11. The computing device of claim 10, in which the processor is configured to divide the electronic paper display into portions to define the group of substantially non-overlapping segments.

12. The computing device of claim 10, in which the electronic paper display reflects ambient light to present content.

13. The computing device of claim 10, in which the electronic paper display is included in the computing device.

14. The computing device of claim 10, in which the electronic paper display is an electrophoretic display.

15. The computing device of claim 10, in which the substantially non-overlapping segments are rectangular shaped.

16. The computing device of claim 10, in which the substantially non-overlapping segments are horizontally adjacent.

17. The computing device of claim 10, in which the display controller applies a charge to a corresponding portion of the electronic paper display to refresh a segment.

18. The computing device of claim 10, in which the sequential manner visually simulates turning a page on the electronic paper display.

19. The computing device of claim 10, in which the sequential manner includes delaying the refreshing of one segment included in the group of segments until another segment is refreshed.

20. One or more computer readable media storing instructions that are executable by a processing device, and upon such execution cause the processing device to perform operations comprising:
individually refreshing substantially non-overlapping segments of an electronic paper display in a sequential manner; and
upon being refreshed, presenting content in each individual refreshed segment.

21. The computer readable media of claim 20 in which the sequential manner includes refreshing adjacent segments in series.

22. The computer readable media of claim 20 in which the sequential manner includes refreshing horizontally adjacent segments in series.

23. The computer readable media of claim 20 in which the sequential manner include refreshing vertically adjacent segments.

24. The computer readable media of claim 20 in which the sequential manner visually simulates turning a page on the electronic paper display.

25. The computer readable media of claim 20 in which refreshing an individual segment includes applying a charge to a corresponding portion of the electronic paper display.

26. The computer readable media of claim 20 in which the segments include at least sixteen segments.

27. The computer readable media of claim 20 in which the sequential manner includes delaying the refreshing of one segment until another segment is refreshed.

28. The computer readable media of claim 20 in which the sequential manner includes delaying the refreshing of one segment until another segment is refreshed and presents content.
